(19) United States
(12) Patent Application Publication
(10) Pub. No.: US 2006/0142907 A1
(43) Pub. Date: Jun. 29, 2006

(54) Method and system for enhanced vehicle diagnostics using statistical feedback

(75) Inventors: Jim J. Cancilla, San Jose, CA (US); Sunil P. Reddy, Corpus Christi, TX (US); Jeff B. Grier, Royal Oak, MI (US); Brad Lewis, Gilroy, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated

(21) Appl. No.: 11/023,997

(22) Filed: Dec. 28, 2004

(51) Int. Cl. G01M 17/00

(52) U.S. Cl. 701/29

(57) ABSTRACT

A diagnostic information portal can communicate with one or more diagnostic devices used to diagnose problems with vehicles. The diagnostic information portal can receive from the diagnostic devices indications of various problems that have been diagnosed with the vehicles. The information received by the diagnostic information portal can then be used to update one or more information sources (e.g., diagnostic procedures or other information) used to diagnose problems with the vehicles.

### FIELD OF THE INVENTION

This invention relates generally to vehicle diagnostics. More specifically, it relates to using statistical feedback to provide enhanced vehicle diagnostics.

### BACKGROUND OF THE INVENTION

Modern vehicles have become increasingly complex, with a typical vehicle including various different mechanical and electrical systems. The particular design and operation of these systems usually varies from vehicle manufacturer to vehicle manufacturer. In order to diagnose and repair a problem in a vehicle, a vehicle repair technician must not only be knowledgeable about the general principles of vehicle design (e.g., engines, transmissions, brake systems, air condition systems and others), but the vehicle repair technician must also be knowledgeable about the manufacturer's particular design for the vehicle to be diagnosed and repaired. Accordingly, modern vehicles require significant volumes of information to diagnose and repair problems.

Generally, information used to diagnose and repair vehicles is distributed in books or other documents. Where the information is stored in hardcopy form, it is usually too bulky and cumbersome to be located right at the repair site and conveniently accessed by the vehicle repair technician. Additionally, the volume of materials may make this cost prohibitive as well. Alternatively, these materials may be stored at a central repository, which may be located at the repair site or away from the repair site. The vehicle repair technician can then go to the central repository in order to access this diagnostic information, but this may increase the amount of time the vehicle repair technician needs to spend in order to diagnose and repair the vehicle.

As an alternative, the information may be stored electronically. The vehicle repair technician can then use a computer or other such device in order to view this information. This may allow the vehicle repair technician to more efficiently and quickly access the diagnostic and repair information when compared to using hardcopies of the diagnostic and repair information. This information, however, might not accurately reflect the actual occurrences of these problems in various vehicles. Thus, the vehicle repair technical may be left with outdated information in order to diagnose and fix a vehicle fault, thereby consuming more of a vehicle repair technician's time to accurately diagnose and fix problems.

Therefore, there exists a need for improved methods and systems for vehicle diagnostics and repair.

### SUMMARY OF THE INVENTION

A diagnostic information portal might communicate with one or more diagnostic devices, which can be used to diagnose problems with vehicles. In diagnosing a problem, the diagnostic information portal can send a diagnostic device information that indicates which problems might be statistically more likely to be the cause of the problem with the vehicle. This information might be in the form of or derived from OEM diagnostic trees, proprietary third party repair procedures, recall notices or other such information. These information sources might be stored by the diagnostic information portal, or they might be stored remotely from the diagnostic information portal.

Once a problem has been diagnosed, the diagnostic device can send the diagnostic information portal an indication of the particular problem that was diagnosed. This might be sent along with an indication of the corresponding vehicle (e.g., make/model, VIN or other identifying information). In one embodiment, the diagnostic device might report the problem back to the diagnostic information portal in real-time. In other embodiments, the diagnostic device might store an indication of the problem and the corresponding vehicle, and it might send this information to the diagnostic information portal at a later time.

The diagnostic information portal can use the information it receives from one or more diagnostic devices to update the various information sources used to diagnose problems. Thus, the statistical likelihood information that is part of the information sources can be updated based on the actual frequency of occurrences of these problems in the vehicles. In various embodiments, the information sources are updated through automated processes. These might occur at a variety of different intervals, such as daily, weekly, monthly or at some other interval, or the automatic updates might be initiated by a system administration or other user.

In other embodiments, the information received by the diagnostic information portal might be used to manually update the information sources. For example, the information about the problems might be presented to an individual, such as on a display or through a printout. The individual can then use that information to manually update one or more of the information sources. Combinations of automated and manual methods are also possible.

These as well as other aspects and advantages of the present invention will become apparent from reading the following detailed description, with appropriate reference to the accompanying drawings.

### BRIEF DESCRIPTION OF THE DRAWINGS

Exemplary embodiments of the present invention are described herein with reference to the drawings, in which:

FIG. 1 is a block diagram of an exemplary system using a diagnostic information portal to provide enhanced vehicle diagnostics using statistical feedback;

FIG. 2 is a block diagram of the diagnostic information portal of FIG. 1;

FIG. 3 is a block diagram of an alternate configuration of a system including the diagnostic information portal;

FIG. 4 is block diagram of an exemplary message flow between the diagnostic device and the diagnostic information portal;

FIG. 5 is a flowchart of an exemplary method for acquiring diagnostic feedback about problems with vehicles; and

FIG. 6 is a flowchart of an exemplary method that may be used in conjunction with the method of FIG. 5 in order to update a diagnostic procedure based on statistical feedback regarding occurrences of problems diagnosed in vehicles.

### DETAILED DESCRIPTION OF EXEMPLARY EMBODIMENTS

I. Exemplary Diagnostic System Architecture

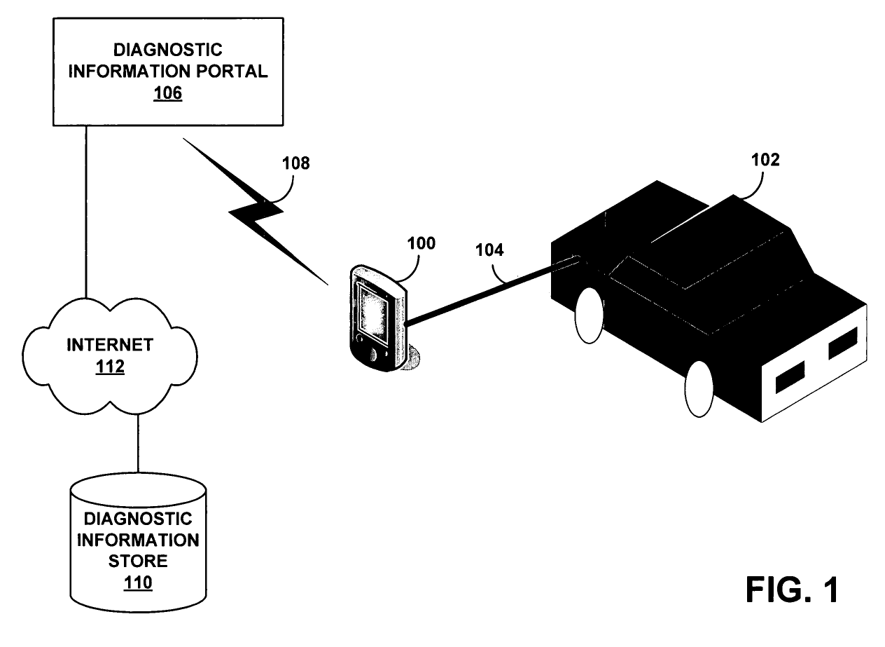

FIG. 1 is a block diagram of an exemplary system using a diagnostic information portal to provide enhanced vehicle diagnostics using statistical feedback. As illustrated in this figure, a diagnostic device 100 interfaces with a vehicle 102 via a wired connection 104. The diagnostic device 100 may be any type of device used by a vehicle repair technician. In various embodiments, the diagnostic device 100 is a personal digital assistant (“PDA”) or other handheld device. It is not necessary, however, that the diagnostic device 100 is a handheld device, and other types of devices may also be used.

The diagnostic device 100 interfaces with the vehicle 102 in order to collect diagnostic information about the vehicle 102, such as can be used to diagnose a problem with the vehicle 102. Although this figure depicts the vehicle 102 as a car, the principles discussed herein are applicable to any type of vehicle. They are also applicable to non-vehicles, such as machinery, industrial equipment or any other object that might need to be diagnosed and repaired. Also, while this figure depicts the diagnostic device 100 interfacing with the vehicle 102 through the wired connection 104, a wireless connection might alternatively be used.

The diagnostic device 100 may interface with one or more systems within the vehicle 102 in order to obtain diagnostic information about those systems. For example, the diagnostic device 100 might obtain information about the vehicle's engine, transmission, electrical systems, air conditioning system, braking system, power steering system or any other systems. The diagnostic device 100 might interface directly with these various systems, as is illustrated in FIG. 1. Alternatively, the diagnostic device 100 might interface with other diagnostic equipment (not shown), which in turn interfaces with various systems or components in the vehicle 102. Other configurations are also possible.

Depending on the vehicle 102 and the particular configuration of the diagnostic device 100 or other equipment, the diagnostic device 100 may automatically obtain information about the various systems in the vehicle 102. That is, the diagnostic device 100 might obtain this information automatically upon being connected to the vehicle 102 or upon an appropriate prompt from a user of the diagnostic device 100. An automated process such as this can allow a vehicle repair technician to quickly and efficiently obtain diagnostic information about various systems in the vehicle 102.

The vehicle repair technician might also manually direct the diagnostic device 100 to perform various tests on the vehicle 102 or to acquire certain other diagnostic information about the vehicle 102. This might be in addition to or in place of the previously described automated diagnostic information collection methods. Thus, the diagnostic device 100 might automatically collect predetermined data, might collect additional data as directed by the vehicle repair technician, or might perform a combination of these to methods in order to acquire the diagnostic information.

Additionally, the vehicle repair technician might input to the diagnostic device 100 information about the problem with the vehicle 102. For example, the vehicle repair technician might input a description of the problem, such as by typing a description of the problem into the diagnostic device 100 or by selecting one or more problems from a drop-down menu or some other preprogrammed selection of possible problems. The vehicle repair technician might also input possible causes of the problem into the diagnostic device 100 or might eliminate possible causes of the problem, such as where the vehicle repair technician has already performed some tests or ruled out some possible causes. The vehicle repair technician might additionally enter other information about the vehicle 102, such as its VIN, its make and model, or other identifying information. Alternatively, this might be collected automatically by the diagnostic device 100 when it is connected to the vehicle 102.

Once the diagnostic device 100 acquires the diagnostic information from the vehicle 102 and any additional information entered by the vehicle repair technician, the diagnostic device 100 may then formulate a request to a diagnostic information portal 106. The diagnostic information portal 106 can provide a centralized location for vehicle repair technicians, through the use of diagnostic devices, to submit diagnostic information and to in return obtain possible causes of problems with their vehicles. The diagnostic information portal 106 can be located at the vehicle repair technician's worksite and be used by multiple vehicle repair technicians at that worksite. Alternatively, the diagnostic information portal 106 can be located at a more central location and might then be accessed by vehicle repair technicians a multiple different worksites. Thus the diagnostic information portal 106 might communicate with multiple diagnostic devices, although this figure illustrates only a single such device.

The diagnostic device 100 preferably communicates with the diagnostic information portal 106 over a wireless communication link 108; however, a wired link or a combination of wired and wireless links might alternatively be used. The wireless communication link 108 can use a variety of different wireless protocols, such as any of the protocols under the Institute of Electrical and Electronics Engineers (“IEEE”) 802.11 umbrella, IEEE 802.16, IEEE 802.20, Bluetooth, code division multiple access (“CDMA”), frequency division multiple access (“FDMA”), time division multiple access (“TDMA”), Global System for Mobile Communications/General Packet Radio Service (“GSM/GPRS”), Bluetooth or others.

In formulating the request, the diagnostic device 100 might include all of the diagnostic information received from the vehicle 102. Alternatively, the diagnostic device 100 might only include part of the diagnostic information received from the vehicle 102, such as that information most directly related to the problem. For example, if the vehicle repair technician indicates that the problem is generally with the transmission, then the diagnostic device 100 might only include the diagnostic information that is related to the transmission. In another example, even where the vehicle repair technician indicates that the problem is with a particular system, the diagnostic device 100 might still include information from other systems in the request. The request might additionally include information about the make, model, year, VIN or other identifying information for the vehicle 102, and the request might also additionally include information entered by the vehicle repair technician.

The diagnostic information portal 106 receives the request from the diagnostic device 100. In response, the diagnostic information portal 106 uses the diagnostic information in the request to search various information sources in order to determine possible causes for the problem. The diagnostic information portal 106 might itself store these various information sources, such as OEM diagnostic trees, proprietary third party repair procedures, publicly available documentation (e.g., recall notices) or any other information sources than can be used to diagnose problems with the vehicle 102. Alternatively, one or more of the information sources might be stored remotely from the diagnostic information portal 106, such as can be accessed by the diagnostic information portal 106 via one or more data networks (e.g., a intranet, a LAN, a WAN, the Internet, etc . . . ).

Once the diagnostic information portal 106 accesses the information sources in order to determine the possible causes of the problem, the diagnostic information portal 106 can then send a list or other description of the possible causes back to the diagnostic device 100. The diagnostic device 100 can in turn display the possible causes of the problem to the vehicle repair technician. Before sending the possible causes back to the diagnostic device 100, the diagnostic information portal 106 might statistically prioritize the possible causes, so as to alert the vehicle repair technician to the more likely causes of the problem. This may aid the vehicle repair technician in more quickly diagnosing and fixing the problem with the vehicle 102.

The diagnostic information portal 106 might determine the statistical priority associated with a possible cause of the problem in a variety of different ways. For example, the diagnostic information portal might first use the VIN, make and model of the vehicle 102 or other identifying information to determine which information sources would even apply to the vehicle 102 and therefore might include information used in determining the cause of the problem. From the information sources that apply to the vehicle 102, then the diagnostic information portal 106 might further narrow the information sources to those that deal with the general system or area of the vehicle that has the problem. For example, if the request indicates that the problem is generally with the transmission and the request further includes diagnostic information for the transmission system, then the diagnostic information portal 106 might further exclude information sources that do not include information on problems with transmissions.

Once the diagnostic information portal 106 determines which information sources it should use, then it might apply the diagnostic information to those information sources. For example, the diagnostic information portal 106 might use the diagnostic information received from the diagnostic device 100 to traverse an OEM diagnostic tree or other diagnostic procedure. When traversing an OEM diagnostic tree, the diagnostic information portal 106 might assign higher statistical priorities to the main branches it traverses based on the diagnostic information. Adjacent branches might be assigned a lower statistical priority, and branches that are even farther removed in the OEM diagnostic tree might be assigned still lower priorities.

In another example, an information store might include a statistical listing of common problems with the particular make and model of the vehicle. For example, vehicle repair technicians might routinely report problems with various makes and models of vehicles and, this information might be compiled (for example, by the vehicle's manufacturer but alternatively by some third party) into the statistical list found in the information store. The diagnostic information portal 106 might start going through the statistical list in the information store to determine, based on the diagnostic information, which problems might apply to the vehicle. For example, the mostly likely problem in the list might be low transmission fluid, but if the diagnostic information store includes a normal transmission fluid reading, then the diagnostic information portal 106 can exclude this problem and then go to the next problem.

It should be understood that these methods for using statistical likelihoods in diagnostic procedures are merely exemplary in nature. A variety of other methods might alternatively be used, and the principles discussed herein are not limited to any particular method.

Once the diagnostic information portal 106 compiles its statistical list of possible problems, it can then send that list back to the diagnostic device 100. Alternatively, the diagnostic information portal might send a diagnostic procedure (e.g., which includes diagnostic information based on the statistical likelihood of various problems) or other such information that can subsequently be used by the diagnostic device to diagnose the problem.

The diagnostic device 100 can display the statistically prioritized list to the repair technician in a variety of different ways. For example, the diagnostic device 100 might just display a list of the possible causes in statistical order. The diagnostic device 100 might additionally display a corresponding statistical percentage or other measure along with the entries in the list. In one embodiment, the diagnostic device 100 displays only a preset number of the possible causes (e.g., the top ten of a list of more than ten possible causes). In various embodiments, the vehicle repair technician might or might not be able to alter the preset number. In another embodiment, the diagnostic information portal 106 itself might limit the number of possible causes sent to the diagnostic device 100 and therefore also the number displayed on the diagnostic device 100.

In another embodiment, the diagnostic information portal 106 might only send to the diagnostic device 100 those possible causes that have a statistical likelihood that is above a predetermined threshold. In yet another embodiment, the diagnostic device 100 might receive a list of possible causes but only display to the user those possible causes in the list that have a statistical likelihood that is above a predetermined threshold. The predetermined threshold might be alterable by the user of the device, although in other embodiments it might be preprogrammed into the device and not alterable by a user of the device. Other methods of displaying the statistical information received from the diagnostic information portal 106 are also possible.

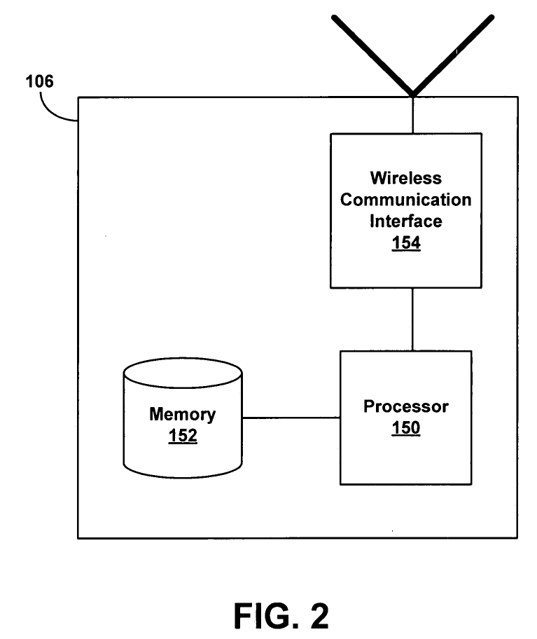

FIG. 2 is a block diagram of the diagnostic information portal of FIG. 1. As depicted, the diagnostic information portal 106 includes a processor 150, which can execute programs and control the diagnostic information portal 106. The diagnostic information portal 106 additionally includes memory 152, such as can be used to stored programs executed on the processor 150 and/or to store data used by the programs. While this figure only depicts a single type of memory, the diagnostic information portal 106 may alternatively include several different types of memory. The diagnostic information portal 106 may additionally include a wireless communication interface 154, which can be used to communicate with the diagnostic device 100 via the wireless communication link 108.

The diagnostic information portal 106 may include other components in addition to those depicted in FIG. 2. For example, the diagnostic information portal 106 may include network interfaces that allow it to communicate with a LAN, WAN or other such network. It may include additional processors, memory or other circuitry. In addition, the diagnostic information portal 106 might be one component of a larger system, and therefore might include circuitry or components for entirely unrelated functions as well.

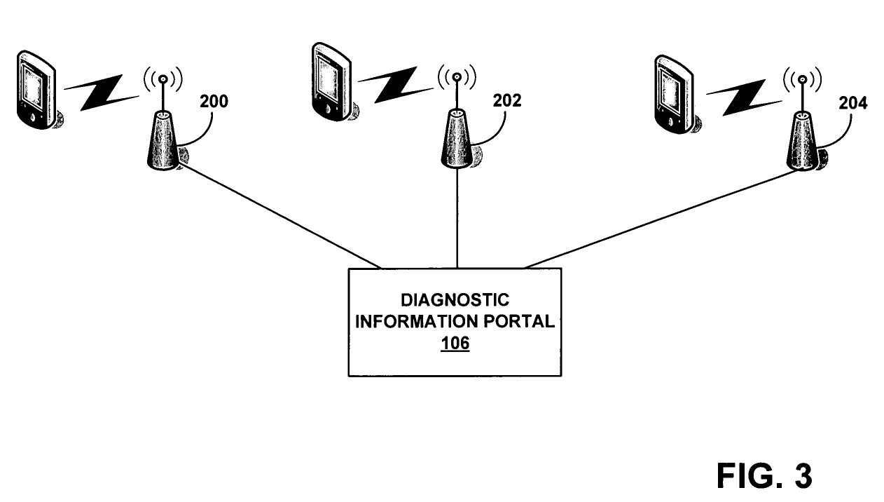

FIG. 3 is a block diagram of an alternate configuration of a system including the diagnostic information portal. As previously described, the diagnostic information portal 106 may use a variety of different air interface protocols, each of which typically has a maximum supported range that may vary depending on the wireless protocol as well as environmental conditions. Thus, the diagnostic device 100 would have to be within approximately a certain distance of the diagnostic information portal 106 in order to wirelessly communicate with the diagnostic information portal 106 via the particular wireless protocol.

In order to extend the range of the diagnostic information portal 106, it may employ one or more access points. FIG. 3 depicts three access points 200, 202, 204 connected to the diagnostic information portal 106, although a greater or fewer number of access point might alternatively be used. The access points 200-204 each interface with the diagnostic information portal 106 via respective wired communication links although wireless communications links might alternatively be used. Each access point 200-204 may communicate with one or more diagnostic devices that are in range of the access point 200-204. The access points 200-204 in turn communicates with the diagnostic information portal 106, thereby extending the range of the diagnostic information portal 106.

While these figures illustrate a single diagnostic information portal 106, a diagnostic system might include more than one diagnostic information portal. Each diagnostic information portal in the system might communicate one or more diagnostic devices. Thus, it should be understood that the configurations described herein are merely exemplary in nature, and many alternative configurations might also be used.

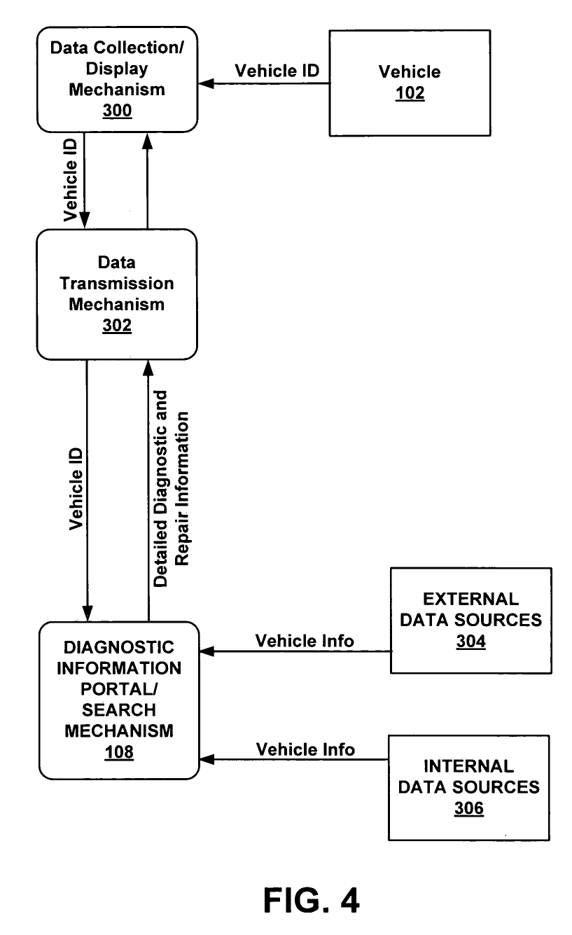

FIG. 4 is block diagram of an exemplary message flow between the diagnostic device and the diagnostic information portal. A data collection/display mechanism 300 can receive diagnostic information, including a vehicle ID, from the vehicle 102. The data collection mechanism 300 can in turn pass the information to a data transmission mechanism 302, which can wirelessly transmit the information to the diagnostic information/search portal 106. In one embodiment, the data collection mechanism 300 and the data transmission mechanism 302 might both be included in the diagnostic device 100; however, one or both of the data collection mechanism 300 and data transmission mechanism may alternatively be located separately from the diagnostic device 100.

The diagnostic information portal 106 can then use the received information to search external data sources 304 and internal data sources 306. The external data sources 304 are located externally from the diagnostic information portal 106, while the internal data sources 306 are located internally to the diagnostic information portal 106. Using information retrieved from the external and internal data sources 304, 306, the diagnostic information portal 106 can compile detailed diagnostic and repair information about the vehicle 102. That information can then be passed back to the data transmission mechanism 302 and to the data collection/display mechanism 300, which can display the information to the vehicle repair technician.

II. Exemplary Diagnostic Information Portal Operation

In addition to receiving requests for information used to diagnose a problem with a vehicle, the diagnostic information portal 106 can also receive information about the problem that was eventually diagnosed with the vehicle 102. For example, once the vehicle repair technician diagnoses the problem with the vehicle 102, the vehicle repair technician can enter that problem into the diagnostic device 100 (e.g., manually typing in the problem, selecting the problem from a drop down menu or some other method). Alternatively, the diagnostic device 100 might determine the problem automatically, such as from information obtained via a connection with the vehicle 102.

Regardless of how the diagnostic device 100 obtains the problem, the problem might be stored in the diagnostic device 100 along with identifying information for the vehicle (e.g., its make/model, VIN or other such information). Because the vehicle repair technician might use the diagnostic device 100 to diagnose problems with many different vehicles, the diagnostic device 100 might potentially store entries for many different problems and their respective vehicles. Also, a particular vehicle might have more than one problem, and therefore the diagnostic device 100 might store more than one problem for a particular vehicle.

The diagnostic device 100 can subsequently report the information about the diagnosed problems back to the diagnostic information portal 106, which can then use the information to update one or more of the information sources used to diagnose problems. Thus, the statistical likelihoods that are a part of the information sources used to diagnose problems with vehicles can be updated based on data about the actual occurrences of these problems in vehicles, thereby potentially increasing the accuracy of the statistical likelihoods associated with the various problems and used in creating information souces.

In one embodiment, the diagnostic device 100 reports these problems back to the diagnostic information portal 106 in real-time. For example, once the diagnostic device 100 receives an indication of a problem that was diagnosed with a particular vehicle, the diagnostic device 100 can proceed to report that problem (and potentially also an indication of the vehicle) back to the diagnostic information portal 106. Thus, in this embodiment, the problems are reported back to the diagnostic information portal 106 contemporaneously with their diagnosis.

In alternate embodiments, the diagnostic device 100 might simply store the indications of the problems and report them back to the diagnostic information portal 106 at a later time. For example, the diagnostic device 100 might be programmed to report the various problems back to the diagnostic information portal 106 at a preset time (e.g., 6:00 pm each day, after 5:00 pm each Thursday, on the 3rd of each month, or some other preset time). In this embodiment, the diagnostic device 100 automatically reports the problems to the diagnostic information portal 106 without requiring any further action by the vehicle repair technician.

In other embodiments, however, the vehicle repair technician might prompt the diagnostic device 100 to report back the problems that it has stored. For example, the diagnostic device 100 might store the problems but only report them back to the diagnostic information portal 106 when prompted by the vehicle repair technician. In another variation, the diagnostic information portal 106 might prompt the diagnostic device 100 to send it the problems. A particular diagnostic device 100 might use one or more of these methods to report the problems back to the diagnostic information portal 106; however, other methods might also be used.

The diagnostic information portal 106 might receive feedback about actual problems with vehicles from a variety of different diagnostic devices. The diagnostic information portal 106 itself can store these problems along with an indication of the vehicle, such as in a database or other storage mechanism. Alternatively, the diagnostic information portal 106 might send this information to another network element, which can then store then information. For example, where the diagnostic system includes more than one diagnostic information portal, the diagnostic information portals might each send the information they receive about problems with vehicles to a network element. The diagnostic system might alternatively use more than one network element, and in some cases the diagnostic devices might even send this information directly to the network element rather than the diagnostic information portal 106.

Once the diagnostic information portal 106 or other network element stores this information about the various problems, it might then be used to update one or more of the information sources. Thus, the diagnostic procedures and other such information used to diagnose problems with vehicles can be updated based on the actual occurrences of problems in the vehicles, thereby potentially providing a more accurate estimation of the statistical likelihoods associated with the various problems.

In one exemplary operation, the information sources might be updated through an automated process. The process might be carried out by the diagnostic information portal 106, another network element, or a combination of different elements. The automated updates might be scheduled to be performed at predetermined times (e.g., 3:00 pm each day, each Thursday at 9 pm, the 4th of each month, etc . . . ). The automated updates might also be performed when one or more predetermined conditions have been met. For example, the automated update process might run when the diagnostic information portal 106 has received a predetermined number of diagnosed problems back from the diagnostic device 100.

It is not necessary that all the information sources be updated simultaneously. For example, some information sources might be scheduled to be updated more often than others. And, some information sources might not be scheduled to be updated at all. Also, the predetermined conditions might have an effect on which particular information sources get updated. For example, if the diagnostic information portal 106 receives a predetermined number of problems about a particular make/model of vehicle, then automated updates might run for only those information sources, or a subset of the information sources, used to diagnose problems with that particular make/model.

In another operation, the information sources might be updated through a manual process. For example, an administrator or other user might print out or otherwise access the information about the problems. Then, a person might use that information to manually update one or more of the information sources. Various combinations of manual and automated processes might also be used.

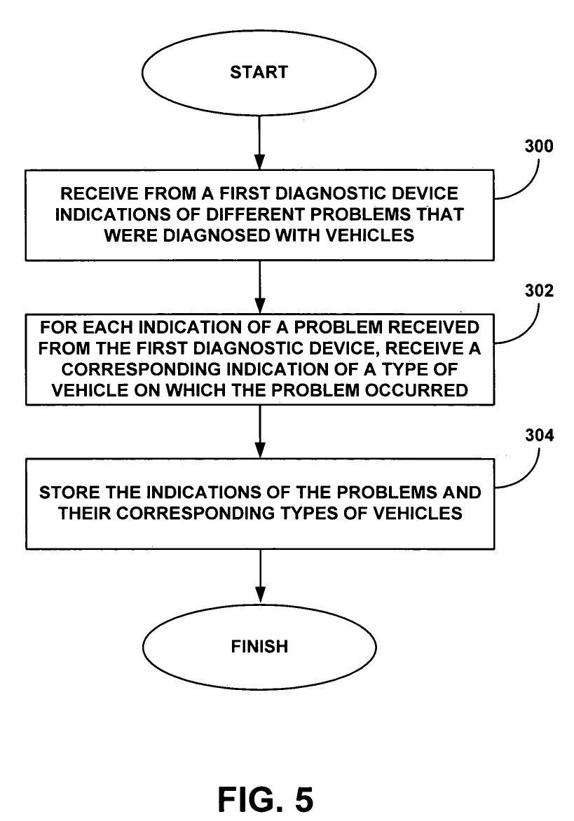

FIG. 5 is a flowchart of an exemplary method for acquiring diagnostic feedback about problems with vehicles. This method might be used as part of updating one or more of the information sources based on statistical information derived from actual occurrences of problems with vehicles. At Step 300, a diagnostic information portal receives from a first diagnostic device indications of different problems that were diagnosed with vehicles.

For each indication of a problem received from the first diagnostic device, the diagnostic information portal receives from the first diagnostic device a corresponding indication of a type of vehicle on which the problem occurred, as shown at Step 302. The corresponding indication of the type of vehicle might be sent together with the indication of the problem, and in fact might even be embedded within the indication of the problem. Alternatively, the corresponding indication of the type of vehicle might be sent separately from the indication of the problem.

At Step 304, the diagnostic device stores the indication of the problems and their corresponding types of vehicles. As previously described, this information might be stored on the diagnostic information portal. Alternatively, the information might be sent from the diagnostic information portal to another element in the diagnostic system, which can then store the information for later retrieval.

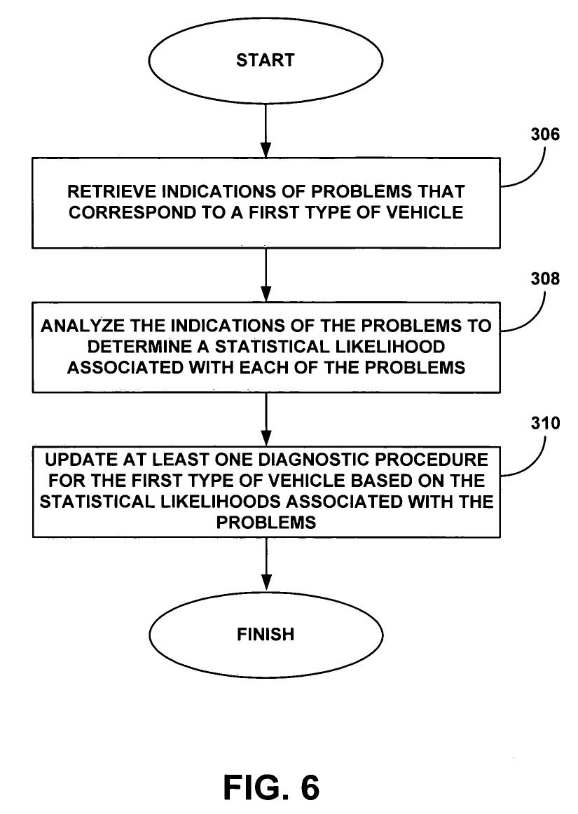

FIG. 6 is a flowchart of an exemplary method that may be used in conjunction with the method of FIG. 5 in order to update a diagnostic procedure based on statistical feedback regarding occurrences of problems diagnosed in vehicles. This method might be executed, for example, after the method of FIG. 5. At Step 306, a device retrieves indications of problems that correspond to a first type of vehicle. The device performing this method might be the diagnostic device, but alternatively might be another device in the diagnostic system. Or, this method might even be performed manually.

The first type of vehicle might be any categorization of a type of vehicle. For example, it might be a particular make of vehicle, a particular make and model of vehicle, a combination of makes of vehicles, a combination of makes and models of vehicles, or some other categorization of vehicles. In retrieving the problems, the device retrieves those problems that have a vehicle type that corresponds to the first type of vehicle. For example, where the first vehicle type is a particular make, the device might retrieve all problems that have a make, make/model or VIN that corresponds to the make that is the first vehicle type.

At Step 308, the device analyzes the indications of the problems to determine a statistical likelihood associated with each of the problems. For example, the device might retrieve indications of various different problems (e.g., problems with a component the electrical system, problems with the battery, problems with components in the transmission, etc . . . ). For each of these problems, the device determines an associated statistical likelihood. For example, the device might determine that some problems occur more frequently than other problems.

At Step 310, the device updates at least one diagnostic procedure for the first type of vehicle based on the statistical likelihoods associated with the problems. The diagnostic procedure might be used in diagnosing all of the problems retrieved by the device at Step 306, or it might only be used in diagnosing one or more of the problems that were retrieved by the device at Step 306. For example, the device might determined statistical likelihood for a variety of different problems, but then only update a diagnostic procedure used to diagnose problems with the transmission.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

We claim:

1. A method for acquiring diagnostic feedback about problems with vehicles, the method comprising:
receiving from a first diagnostic device indications of different problems that were diagnosed with vehicles;
for each indication of a problem received from the first diagnostic device, receiving a corresponding indication of a type of a vehicle on which the problem occurred; and
storing the indications of the problems and their corresponding types of vehicles.

2. A computer readable medium having stored therein instructions for causing a processor to execute the method of claim 1.

3. The method of claim 1, further comprising:
retrieving the indications of the problems that correspond to a first type of vehicle;
analyzing the indications of the problems to determine a statistical likelihood associated with each of the problems; and
updating at least one diagnostic procedure for the first type of vehicle based on the statistical likelihoods associated with the problems.

4. The method of claim 3, further comprising performing the method of claim 3 at predetermined intervals.

5. The method of claim 3, further comprising:
receiving from the first diagnostic device a request to diagnose a problem with a first type of vehicle; and
in response to the request, sending the first diagnostic device the updated diagnostic procedure.

6. The method of claim 1, wherein the indications of the problems received from the first diagnostic device are received via a wireless communications interface.

7. The method of claim 1, wherein at least one of the indications of a type of a vehicle is an indication of a make of the vehicle, a make and model of the vehicle, or a VIN of the vehicle.

8. The method of claim 1, wherein the first diagnostic device is a handheld device used by a vehicle repair technician to diagnose problems with vehicles.

9. The method of claim 1, further comprising:
receiving from a second diagnostic device indications of different problems that were diagnosed with vehicles;
for each indication of a problem received from the second diagnostic device, receiving a corresponding indication of a type of a vehicle on which the problem occurred; and
storing the indications of the problems and their corresponding types of vehicles.

10. The method of claim 9, further comprising:
from the indications received from the first and second diagnostic devices, retrieving the indications of the problems that correspond to a first type of vehicle;
analyzing the indications of the problems to determine a statistical likelihood associated with each of the problems; and
updating at least one diagnostic procedure for the first type of vehicle based on the statistical likelihoods associated with the problems.

11. The method of claim 1, further comprising directing the first diagnostic device to send the indications of the different problems that were diagnosed with vehicles.

12. A system for updating diagnostic procedures used to diagnose problems with vehicles, the system comprising:
a plurality of diagnostic devices, wherein the diagnostic devices are used by vehicle repair technicians to diagnose problems with vehicles;
a diagnostic information portal, wherein the diagnostic information portal communicates with the diagnostic devices in order to provide the diagnostic devices with diagnostic procedures, and wherein the diagnostic information portal receives from the diagnostic devices indications of various problems that were diagnosed with vehicles, and for each problem, a corresponding type of vehicle on which the problem occurred;
an information store for storing diagnostic procedures used to diagnose problems with vehicles, and wherein the diagnostic procedures are based, at least in part, on statistical likelihoods of various problems with the vehicles.

13. The system of claim 12, further comprising a plurality of wireless access points for communicating with the diagnostic devices, wherein each access point is communicatively coupled with the diagnostic information portal.

14. The system of claim 12, further comprising a plurality of diagnostic information portals.

15. The system of claim 14, wherein the diagnostic information portal are connected via a computer network.

16. The system of claim 14, further comprising data storage for storing indications of problems and corresponding types of vehicles sent to the diagnostic information portals by the diagnostic devices.

17. The system of claim 12, further comprising an update component, wherein the update component uses the indications of various problems that were diagnosed with vehicles and the corresponding types of vehicles on which the problems occurred to derive a statistical likelihood of occurrences of the problems, and wherein the update component uses the statistical likelihood of occurrences of the problems to update at least one diagnostic procedure stored in the information store.

18. A method for updating diagnostic procedures, the method comprising:
receiving from a plurality of diagnostic devices indications of different problems that were diagnosed with vehicles, and for each indication of a problem received from one of the diagnostic devices, receiving a corresponding indication of a type of a vehicle on which the problem occurred;
based on the indications of the different problems that were diagnosed with the vehicle, determining a statistical likelihood that one of the problems will occur; and
based on the statistical likelihood that the one problem will occur, updating a diagnostic information source that is used to diagnose problems with vehicles.

19. A computer readable medium having stored therein instructions for causing a processor to execute the method of claim 18.

20. The method of claim 18, wherein the diagnostic information source is a diagnostic procedure, a diagnostic tree or a repair procedure.

21. The method of claim 18, wherein the indications of the different problems are received from the diagnostic devices via a wireless communications interface.

22. The method of claim 21, wherein the diagnostic information source is accessible by the diagnostic devices via the wireless communications interface.
